(19) United States
(12) Patent Application Publication
(10) Pub. No.: US 2017/0254681 A1
(43) Pub. Date: Sep. 7, 2017

(54) APPARATUS FOR PRECISE LOCATION OF SENSORY EQUIPMENT WITHIN A VESSEL

(71) Applicants: Troy Vincent Ellison, Arroyo Grande, CA (US); Charles Hayes Ellison, Arroyo Grande, CA (US); Michael Hayes Ellison, Arroyo Grande, CA (US); Chris Kevin Nally, Nipomo, CA (US)

(72) Inventors: Troy Vincent Ellison, Arroyo Grande, CA (US); Charles Hayes Ellison, Arroyo Grande, CA (US); Michael Hayes Ellison, Arroyo Grande, CA (US); Chris Kevin Nally, Nipomo, CA (US)

(21) Appl. No.: 15/448,431

(22) Filed: Mar. 2, 2017

Related U.S. Application Data
(60) Provisional application No. 62/303,018, filed on Mar. 3, 2016.

(51) Int. Cl. G01D 11/30

(52) U.S. Cl. CPC G01D 11/30

(57) ABSTRACT

An apparatus for attachment to a vessel for precise measuring within strata is disclosed. The apparatus includes a strut with a vertical slide channel. A probe assembly includes a tube body for sliding along the vertical channel, a flange and a coupling for receiving sensory equipment. The position of the sensory equipment is controlled by positioning the probe assembly within the vertical slide channel.

### REFERENCES TO RELATED APPLICATIONS

This application relies on the priority of U.S. provisional application Ser. No. 62/303,018 having a filing date of 3 Mar. 2016, the disclosure of which is incorporated herein by reference.

### BACKGROUND

Field

The embodiments herein relate generally to measurement systems and more particularly, an apparatus for precise location of sensory equipment within a vessel.

Related Art

In water and wastewater treatment plants there is a problem with the accurate and safe location of sensory equipment in a vertical plane of the vessels in which the intended sensory equipment is meant to be installed for monitoring purposes. Currently, sensory equipment is simply put into vessels with no support mechanisms. This causes inaccurate composite readings, due to the inability of sensors to be suspended consistently within the same strata of intended measurement. The measurement environment tends to be turbulent due to agitation or aeration within the vessel which causes premature failure of the sensory equipment due to collisions with the vessel or other equipment.

As can be seen, there is a need for an apparatus that protects sensory equipment and controls its position within strata for reliable measurements.

### SUMMARY

According to one embodiment of the present invention, an apparatus for taking repeatable measurements within a vessel comprises an elongated strut, the strut including a vertical slide channel; and a probe slide assembly configured for slidable receipt along a length of the vertical slide channel, the probe slide assembly including a hollow tube body, a flange extending radially from the hollow tube body, and a coupling attached to the flange for receipt of sensory equipment.

### BRIEF DESCRIPTION OF THE DRAWINGS

The detailed description of some embodiments of the present invention is made below with reference to the accompanying figures, wherein like numerals represent corresponding parts of the figures.

FIGS. 1A-1C show pictorial, side and top views of a probe slide assembly in accordance with an exemplary embodiment of the subject technology:

FIG. 2 shows the probe slide assembly as inserted into a vertical channel of a strut supported on a wall of the tank;

FIG. 3 shows the probe slide assembly in the vertical channel with an exemplary probe supported by the probe slide assembly; and,

FIG. 4 shows the probe slide assembly in the vertical channel with an exemplary probe in an inverted orientation supported by the probe slide assembly.

### DETAILED DESCRIPTION

The word “exemplary” is used herein to mean “serving as an example or illustration.” Any aspect or design described herein as “exemplary” is not necessarily to be construed as preferred or advantageous over other aspects or designs.

By way of example, and referring to the drawings in general, embodiments of the subject technology provide a probe slide for sensors/sensory equipment which is controllably movable along a strut so that the sensors are positioned in strata to be measured. The sensory equipment is attached to the probe slide assembly (typically by a threaded connection), and inserted into the vertical channel of a strut. The strut is configured for attachment to a vessel being placed within a measurement environment, for example flowing water and wastewater. The vertical channel may have an adjustable probe stop, which has been pre-determined prior to installation.

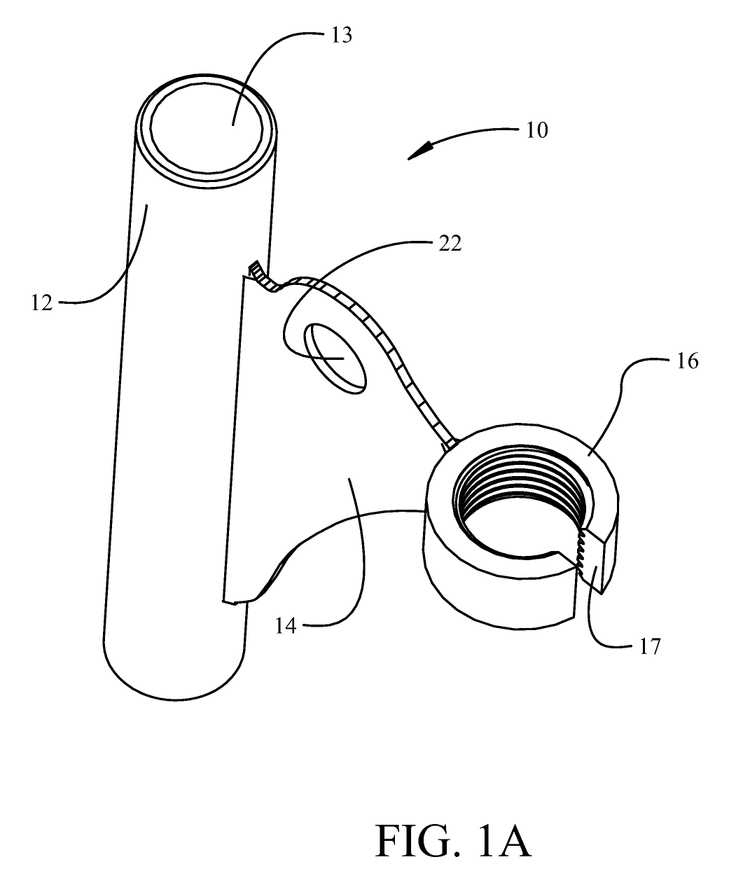

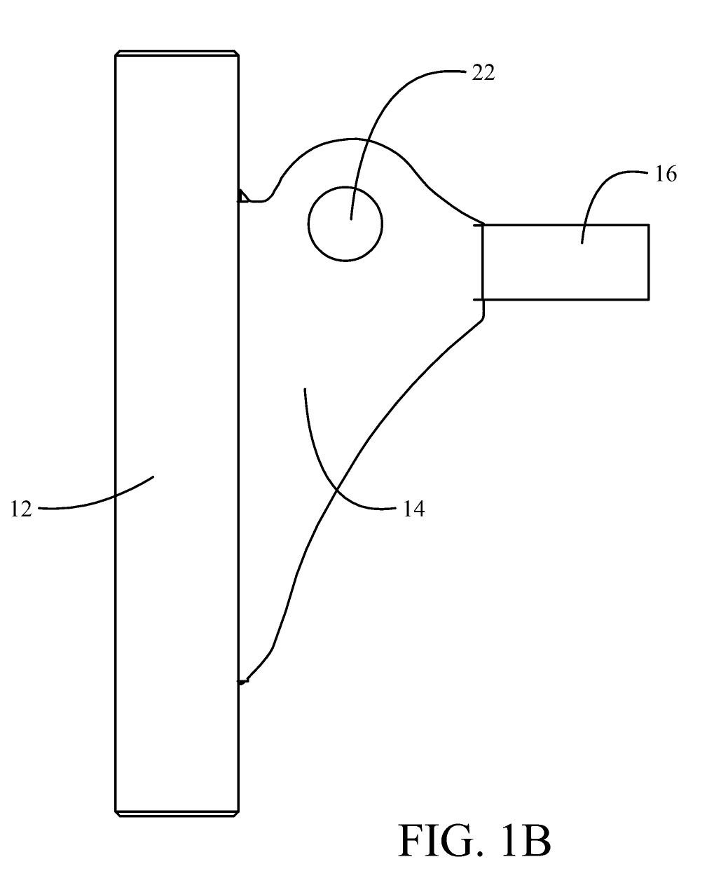

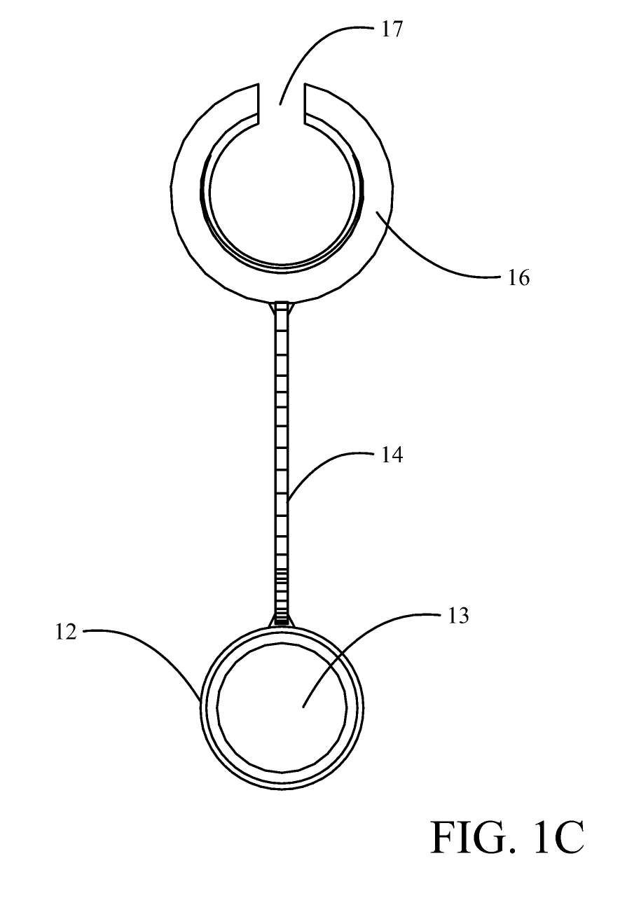

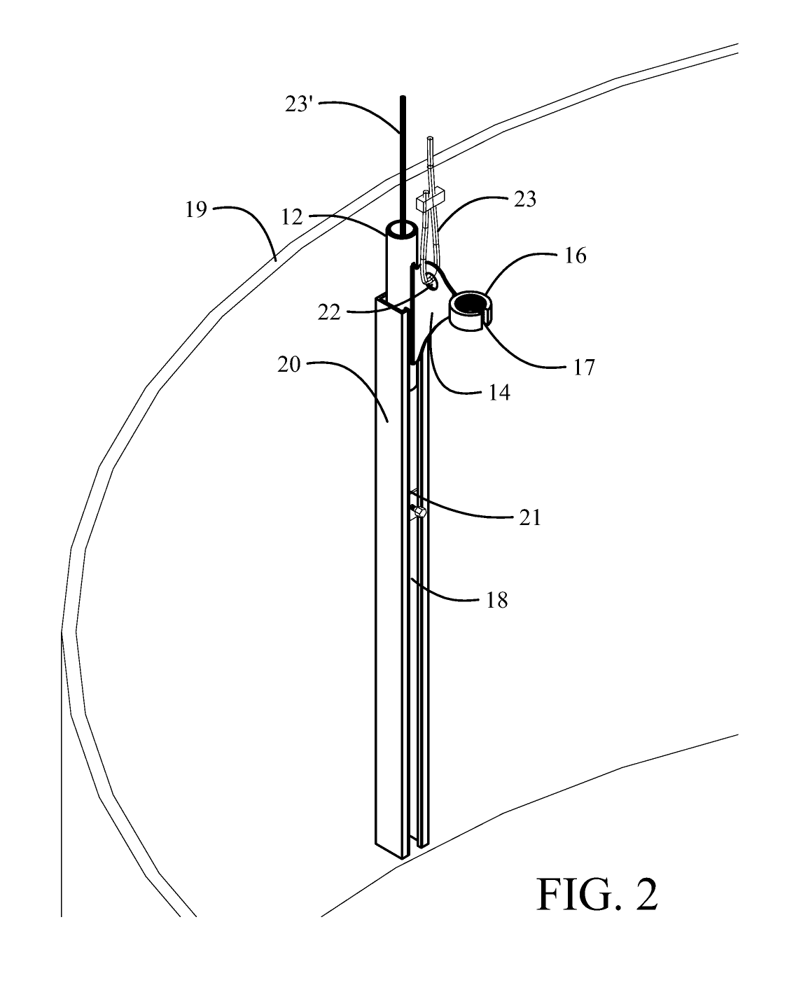

Referring to the drawings, an exemplary probe slide assembly 10, as seen in FIGS. 1A-1C includes a hollow tube body 12 and a flange 14 extending radially from the tube body. A coupling 16, which is threaded for the exemplary embodiment is attached to the flange 14 for receipt of sensory equipment such as a probe, as will be shown in greater detail subsequently. In various embodiments, the hollow tube body 12 may be cylindrical or square to facilitate being received in and sliding up and down within a vertical channel 18 in a strut 20 attached in a conventional manner to the wall 19 of a tank or channel as seen in FIG. 2. A stop 21, which for the embodiment shown is a bolt with a threaded press plate, is engaged in the vertical channel at a desired position. In some embodiments, the probe slide assembly 10 may be affixed to a pulley cable 23 through eyelet 22 in the flange 14 or may be temporarily attached to a cable 23′ routed within the vertical channel 18 of the strut 20 through a bore 13 of the tube body 12.

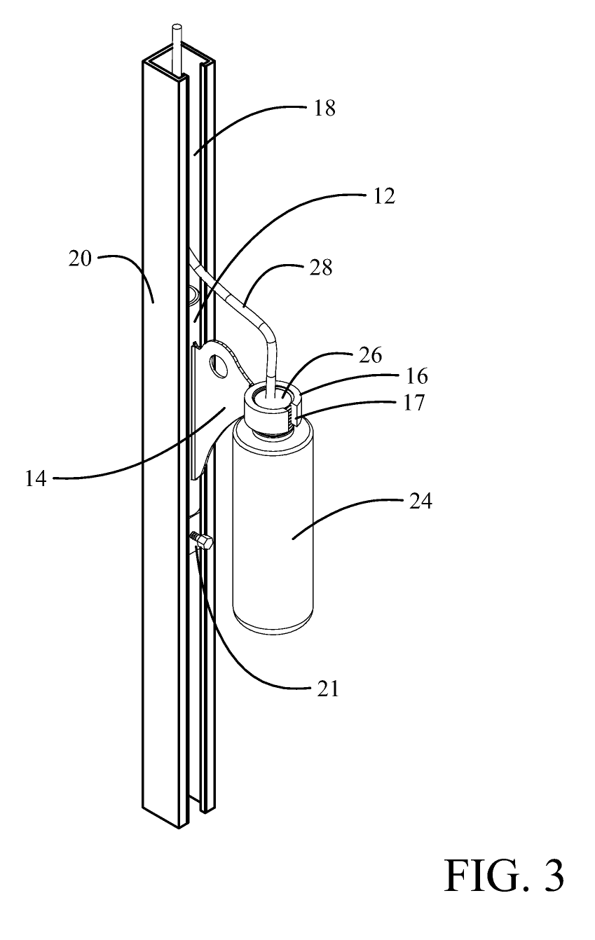

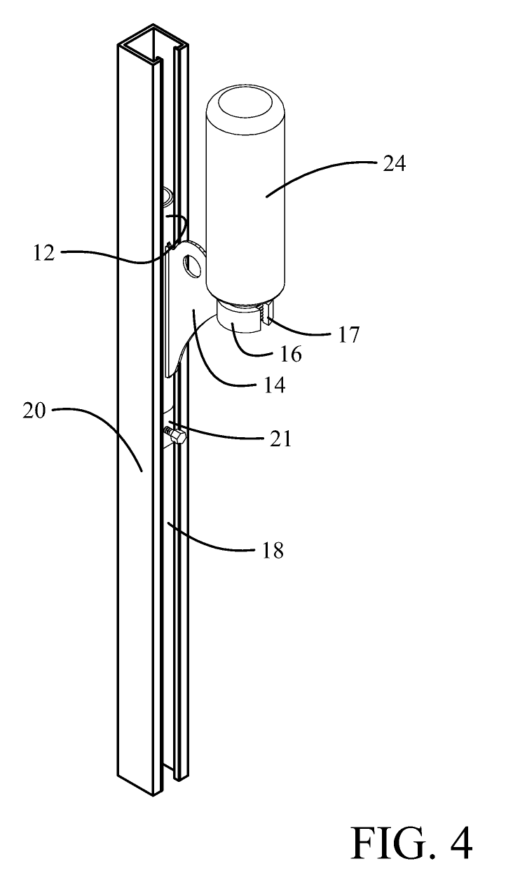

As seen in FIGS. 3 and 4, the body 12 of the probe slide assembly 10 is received in the vertical channel 18. A probe 24 is attached to the coupling 16 with a threaded nipple 26 extending from an end of the probe. In alternative embodiments, a pipe nipple extending from the probe may be clamped into the coupling. Wiring 28, for example, cables attached to the probe or other sensory equipment associated with the probe may also be routed through the vertical channel 18 in the strut 20. Coupling 16 may include a slot or opening 17 to receive wiring on the probe 24 without being threaded through the bore.

The probe slide assembly may be manufactured from welded stainless steel, injection molded plastic or 3D printed from various plastics. The vertical channel may be formed using a strut type channel with mounting brackets being welded onto a desired length of channel as is known in the art. The stop 21 is manufactured from stainless steel. Removal cables by be a stranded stainless steel cable with crimped ends.

In use, the operator slides the probe slide by actuating the pulley cable along the vertical slide channel. In the alternative, the length of cable may be based on the position of the probe stop and the probe slide may be tied to the cable and slid down the vertical slide channel until reaching the stop. The cable may be detached from the probe slide and stored.

As may be appreciated, the probe slide and strut allow for precise vertical alignment of the sensory equipment in the desired vessel's strata, as well as secure alignment horizontally, limiting movement in even the most turbulent of environments. The precision and accuracy in positioning the sensory equipment allows for repeatability during maintenance of the equipment. It provides for quick and easy removal and subsequent re-installation of the sensory equipment. The units are rigid and built to last for decades in the intended environment. The units are easily adapted to all sensory equipment.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. An apparatus to support sensory equipment for taking repeatable measurements within a vessel, comprising:
an elongated strut, the strut having a vertical channel; and
a probe slide assembly configured to be slidably positioned within a length of the vertical channel, the probe slide assembly including
a hollow tube body sized to be received in the vertical channel,
a flange extending radially from the hollow tube body, and
a coupling attached to the flange for receipt of sensory equipment.

2. The apparatus as defined in claim 1 further comprising a stop positioned within the vertical channel.

3. The apparatus as defined in claim 1 further comprising a cable attached to the probe slide assembly for adjustment of the height of the probe slide assembly in the vertical channel.

4. The apparatus as defined in claim 3 wherein the cable is routed through a bore in the hollow tube body.

5. The apparatus as defined in claim 3 wherein the cable is attached to an eyelet in the flange.
